(19) United States
(12) Patent Application Publication
(10) Pub. No.: US 2006/0150745 A1
(43) Pub. Date: Jul. 13, 2006

(54) Sensor having a self-test

(76) Inventor: Markus Lang, Reutlingen (DE)

Correspondence Address: KENYON & KENYON LLP, ONE BROADWAY, NEW YORK, NY, 10004, US

(21) Appl. No.: 11/289,232

(22) Filed: Nov. 28, 2005

(30) Foreign Application Priority Data
Dec. 2, 2004 (DE) 10 2004 058 183.5

(51) Int. Cl. G01N 3/20

(52) U.S. Cl. 73/849

(57) ABSTRACT

A sensor has a self-test function, a movable part and an evaluation unit. The movable part has its own drive. The measured variable is represented by a deflection of the movable part with respect to a reference position. Because of the drive, there is at least one additional, parasitic deflection of the movable part. The self-test function is implemented by the valuation of the parasitic deflection in the evaluation unit.

### CROSS-REFERENCE TO RELATED APPLICATIONS

The present application claims priority to Application No. 10 2004 058 183.5, filed in the Federal Republic of Germany on Dec. 2, 2004, which is expressly incorporated herein in its entirety by reference thereto.

### FIELD OF THE INVENTION

The present invention relates to a sensor having a self-test function, a movable part and an evaluation unit. The movable part, in this context, has its own drive. The measured variable is represented by a deflection of the movable part with respect to a reference position. Because of the drive, there is at least one additional parasitic deflection of the movable part.

### BACKGROUND INFORMATION

Sensors in applications that are critical to safety are furnished, as a rule, with self-test functions, so that, in the case of starting or also during operation, the correct functioning of the sensor may be tested. In the case of an incorrect self-test response, the signal-processing system (e.g., a control unit) is able to indicate the error function via a warning lamp, and to deactivate the appropriate safety systems. Thereby the user, on the one hand, is warned that his respective safety system is not available, and that he should go to a repair shop, and, on the other hand, by the deactivation, a possible false release may be avoided.

In order to generate a self-test signal, additional drive components may be required which stimulate the sensor in the same manner as would happen if a measured variable to be sensed were present, for example, in the case of an acceleration sensor, the seismic mass would be deflected in the same direction and with a comparable amplitude by an electrostatic force on additional electrodes, as would happen in the case of a real acceleration, and by the same arrangement. In the case of a rotation rate sensor or yaw rate sensor, a coriolis force may be simulated by applying an electrostatic force at additional electrodes, and the sensor is stimulated according to its measured variable. Using this method, both the mechanical mobility of sensors and the electrical signal path may be tested.

### SUMMARY

An example embodiment of the present invention may provide a sensor having a self-test function, a movable part and en evaluation unit. In this context, the movable part has its own drive. The measured variable is represented by a deflection of the movable part with respect to a reference position. Because of the drive, there is at least one additional, parasitic deflection of the movable part. The self-test function may be implemented by the evaluation in the evaluation unit of the parasitic deflection. In this context, it may be provided that no additional, separate drive is provided for the self-test function.

The parasitic deflection may be independent of the measured variable. This may permit carrying out the self-test even during the measuring operation.

The parasitic deflection may take place in the same direction as the measured variable. This may permit an evaluation of the deflectability of the movable part in the direction predefined by the measured variable.

The drive may be suitable for setting the movable part into a drive vibration. From a periodic drive motion there also follows a periodic parasitic deflection, which is able to be detected and evaluated, e.g., using electronic evaluation devices.

The parasitic deflection may be proportional to the amplitude of the drive vibration of the movable part. By control of the drive vibration, this may make it possible to evaluate the resulting parasitic deflection quantitatively.

The parasitic deflection may be phase-shifted with respect to the deflection by the measured variable. The parasitic deflection may easily be isolated from the deflection as a result of the measured variable of the sensor and evaluated in the evaluation unit by simple electronic device(s), such as by a phase-sensitive amplifier. The phase-sensitive evaluation of the parasitic deflection represents an example embodiment hereof.

The parasitic deflection may effect a signal offset of the measured signal representing the measured variable. The self-test function may be implemented by an evaluation of this signal offset. An example embodiment of the sensor includes that the self-test function is implemented by the evaluation of the signal offset of the measured signal that represents the measured variable.

The sensor may be a micromechanical sensor. Micromechanical sensors may draw special benefit from the omission of an additional drive for a self-test function, because valuable space may be saved on the sensor element, which may then be utilized constructively for the actual measuring objective.

An example embodiment of the sensor may provide that the sensor is arranged as a micromechanical rotation rate sensor. In this context, the movable part may be arranged as a seismic vibrating mass. The drive may be arranged as a capacitive drive structure that is suitable for setting the seismic vibrating mass into a drive vibration. Besides the amplitude of the drive vibration, the vibrating mass may have an additional parasitic deflection in at least one measuring direction for the rotation rate. The parasitic deflection comes about, based on the inhomogeneities of the sensor structure, which, in general, is a given in each micromechanical sensor.

Example embodiments of the present invention may make use of the parasitic characteristic motion (quadrature) of active sensors (such as a rotation rate sensor) for evaluating the mechanical and electrical signal path. An additional self-test structure, e.g., in the form of self-test drives, may no longer be necessary, whereby sensor area and area on the evaluation chip may be saved.

The testing of the mechanics of the sensor and the appertaining evaluation circuit may no longer take place via additional structures, but by the evaluation of the motion that is created in every sensor by local inhomogeneities (the so-called quadrature). Certain advantages may derive from this. First of all, one may do without the additional structures to the actual sensor, for applying a test signal, that are conventionally necessary. This may yield a saving in space on the sensor element and in the evaluation circuit. The principle is applicable both for sensors having vertical and lateral test signal stimulation. Furthermore, in the case of micromechanical sensors, the omission of additional contacting units may bring along with it an omission of contacting areas (bondpads). This may yield an additional savings in area on the sensor element and in the evaluation circuit. Because of the omission of the test structures, the design possibilities for the sensor may become broader. As a result of the greater space availability, for example, larger useful signal electrodes may be possible for detecting the deflection of the movable part. The self-test signal may have no temperature effects or aging effects.

According to an example embodiment of the present invention, a sensor includes: a self-test function; a movable part having its own drive; and an evaluation unit. A measured variable is represented by a deflection of the movable part with respect to a reference position, the drive adapted to provide at least one additional, parasitic deflection, the self-test function implemented by valuing the parasitic deflection in the evaluation unit.

An amplitude of the parasitic deflection may be independent of an amplitude of the deflection by the measured variable.

The parasitic deflection may take place in the same direction as the measured variable.

The drive may be adapted to set the movable part into a drive vibration.

The parasitic deflection may be proportional to an amplitude of the drive vibration of the movable part.

The parasitic deflection may be phase-shifted with respect to the deflection caused by the measured variable.

The self-test function may be implemented by a phase-sensitive evaluation of the parasitic deflection

The self-test function may be implemented by a phase-sensitive evaluation of the parasitic deflection using a phase-sensitive amplifier.

The parasitic deflection may effect a signal offset of the measuring signal representing the measured variable.

The self-test function may be implemented by evaluation of the signal offset of the measuring signal representing the measured variable.

The sensor may be arranged as a micromechanical sensor.

The sensor may be arranged as a rotation rate sensor.

The movable part may be arranged as a seismic vibrating mass, the drive may be designed as a capacitive drive structure that is suitable for setting the seismic vibrating mass into a drive vibration, and besides the amplitude of the drive vibration, the vibrating mass may have an additional parasitic deflection in at least one measuring direction for the rotation rate.

Exemplary embodiments of the present invention are explained in greater detail in the following description with reference to the appended Figures.

### BRIEF DESCRIPTION OF THE DRAWINGS

FIGS. 1A and 1B illustrate a conventional micromechanical functional part of a rotation rate sensor having self-test electrodes.

FIGS. 2A and 2B illustrate a micromechanical functional part of a rotation rate sensor according to an example embodiment of the present invention without self-test electrodes and having enlarged useful signal electrodes.

FIG. 3 is a schematic view of a conventional rotation rate sensor having a self-test function.

FIG. 4 is a schematic view of a rotation rate sensor according to an example embodiment of the present invention having a self-test function without a self-test drive.

### DETAILED DESCRIPTION

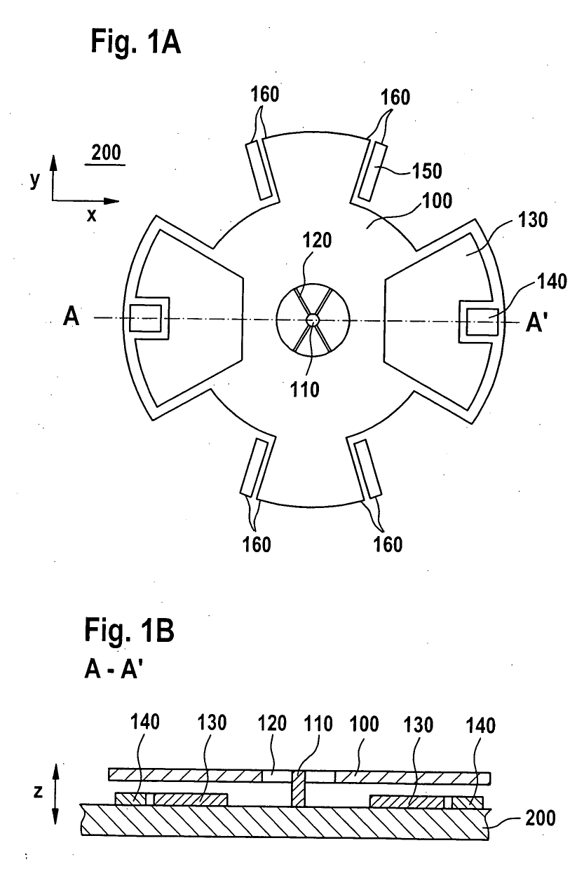

FIGS. 1A and 1B illustrate the micromechanical functional part of a conventional rotation rate sensor having self-test electrodes. FIG. 1A illustrates the micromechanical functional part in a through view from above. FIG. 1B is a cross-sectional view of the micromechanical functional part. What is illustrated is a movable part 100, which is the verification element of the rotation rate sensor. Movable part 100 is fastened to a substrate 200 via vibratory springs 120 and a suspension 110 such that it is able to carry out rotary vibrations in the substrate plane (x, y), stimulated by a drive structure 160. The micromechanical functional part, at substrate 200, also has measuring electrodes 130, test electrodes 140 and drive electrodes 150. Drive electrodes 150, together with movable part 100 that is opposite, form drive structures 160. In this example, drive structures 160 represent a capacitive drive. Test electrodes 140 on substrate 200, together with movable part 100 that is opposite, form an additional drive structure for the self test of the sensor. Movable part 100 is deflected in the z direction, perpendicularly to the substrate plane (x, y) by self-test drive 100, 140, which is capacitive, in this example. This direction z of the deflection also corresponds to the deflection as a result of an acting measured variable, here the coriolis force, in the detection. Measuring electrodes 130 on substrate 200, together with movable part 100, that is opposite, form a capacitor structure for the identification of the deflection of movable part 100. A deflection of movable part 100 in the direction perpendicular to the substrate plane has the effect of a change in the clearance of electrodes 100 and 130 with respect to each other, that act as capacitor plates, and therewith a measurable change in capacity.

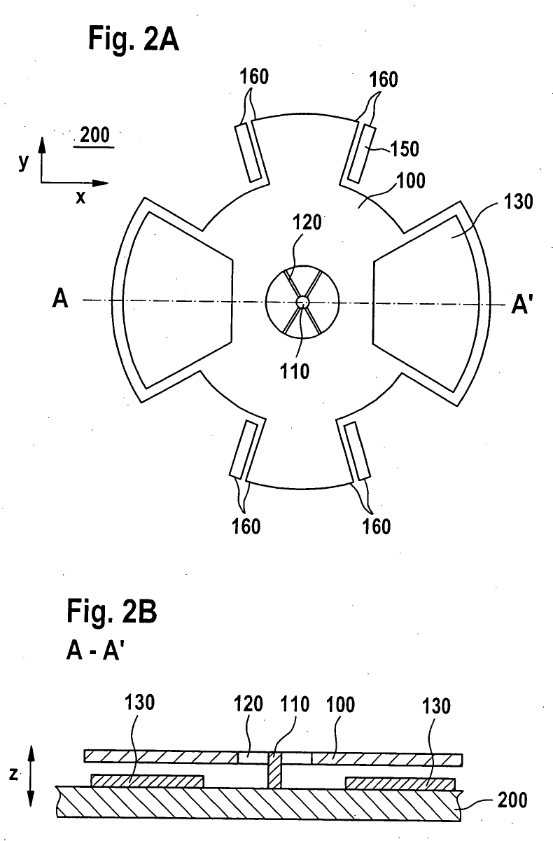

FIGS. 2A and 2B illustrate the micromechanical functional part of a rotation rate sensor according to an example embodiment of the present invention without self-test electrodes and having enlarged useful signal electrodes.

By contrast to the conventional rotation rate sensor, which is shown in FIG. 1, no test electrodes are present. Measuring electrodes 130, in addition, take the place of omitted test electrodes 140 and are arranged to be correspondingly larger.

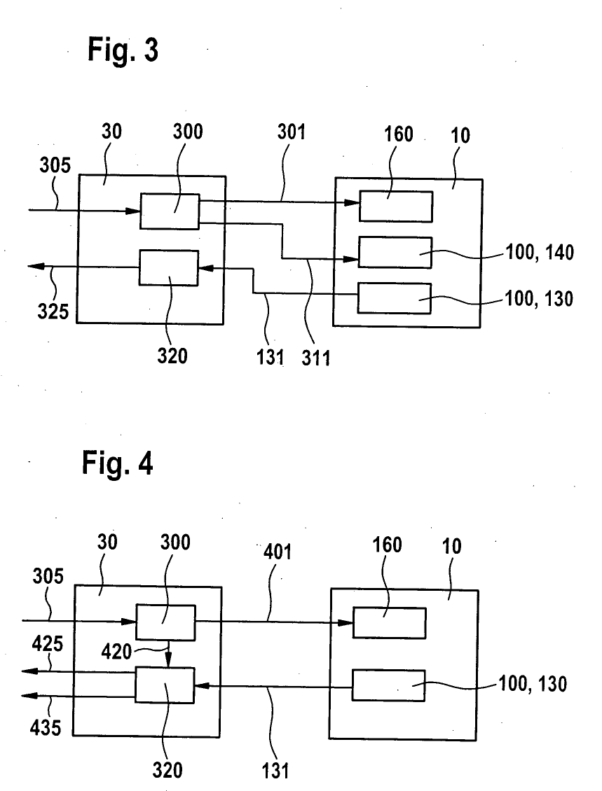

FIG. 3 schematically illustrates and in exemplary fashion, a conventional rotation rate sensor having a self-test function. The sensor has a micromechanical functional part 10 having a movable part 100, measuring electrodes 130, test electrodes 140 and a drive structure 160. The micromechanical part of the sensor is arranged according to FIG. 1. Moreover, the sensor has an electrical circuit 30, having a drive unit 300 for generating a drive vibration and for generating a test deflection for the self-test function, as well as an evaluation unit 320 for evaluating the deflection of movable part 100.

Drive unit 300 generates an electrical drive signal 301, which is conducted to capacitive drive structure 160. By periodic electrostatic action of force on movable part 100, the latter is driven to perform a drive vibration. Movable part 100 is able to be deflected in measuring direction z, as a result of an intervening coriolis force, as described in relation to FIG. 1.

If drive unit 300 has a test query signal 305 conducted to it, it generates an electrical test drive signal 311, which is conducted to test drive structure 100, 140, which has test electrode 140 and the electrode arranged opposite in the form of movable part 100. With the aid of electrostatic action of force, resulting from the charging of the test drive structure, movable part 100 is also deflected in the measuring direction z.

The deflection in direction z is detected as a capacity change by measuring electrode 130 and the electrode arranged opposite, in the form of movable part 100, and is conducted as deflection signal 131 to evaluation unit 320. Evaluation unit 320 outputs sensor signal 325 in correspondence to the deflection. Sensor signal 325 may be the result of a measurement or a self test, as a function of test query signal 305.

FIG. 4 schematically illustrates and in exemplary fashion, a rotation rate sensor according to an example embodiment of the present invention having a self-test function without a self-test drive. The sensor has a micromechanical functional part 10 having a movable part 100, measuring electrodes 130, and a drive structure 160. The micromechanical part of the sensor is arranged as illustrated in FIGS. 2A and 2B. Moreover, the sensor has an electrical circuit 30, having a drive unit 300 for generating a drive vibration and for generating a test deflection for the self-test function, as well as an evaluation unit 320 for evaluating the deflection of movable part 100.

Drive unit 300 generates an electrical drive signal 401, which is conducted to capacitive drive structure 160. By periodic electrostatic action of force on movable part 100, the latter is driven to perform a drive vibration. Movable part 100 is able to be deflected in measuring direction z, as a result of an intervening coriolis force, as described in relation to FIG. 1. Because of the larger design of measuring electrodes 130 as a result of the omission of test electrodes 140, as illustrated in FIGS. 2A and 2B, the rotation rate sensor according to an example embodiment of the present invention has an increased sensitivity.

In addition, movable part 100, as a result of inhomogeneities and imperfect mass distribution of the micromechanical sensor structures, has a further, so-called parasitic deflection in measuring direction z. In the sensor according to an example embodiment of the present invention described herein, this parasitic deflection is utilized for the self-test, without an additional test drive. The parasitic deflection, in this example, is proportional to the amplitude of the drive vibration. Other functional dependencies are possible. Thus, parasitic deflections of certain amplitudes occur as a function of the amplitude of the drive vibration. Moreover, the parasitic deflection has a different phase position with respect to the deflection caused by the measuring variable. For the self-test of the sensor, a drive signal 401 having variable amplitude is generated by drive unit 300 and conducted to drive structure 160. Data on the amplitude and phase of drive signal 401 are also conducted to evaluation unit 320, which is illustrated symbolically in signal 420.

The deflection of movable part 100 in direction z is detected as a capacity change by measuring electrode 130 and the electrode arranged opposite, in the form of movable part 100, and is conducted as deflection signal 131 to evaluation unit 320. For the evaluation of deflection signal 131, one may simply draw upon the amplitude and the phase relation of signals 401 and 131. In evaluation unit 320, deflection signal 131 is evaluated for this in a phase-sensitive manner, and from this there is generated a measuring signal 425 and a test signal 435. This principle may be transferred to additional actively operated mechanical sensors.

Besides the actual measuring signal, actively operated sensors supply a signal that is phase-shifted by 900 on account of inhomogeneities of the sensor structure, the so-called quadrature. The magnitude of this quadrature signal is a function, on the one hand, of the magnitude of the inhomogeneity, and, on the other hand, also of the deflection of the active sensor core, regardless of whether a rotational or a translational motion is involved, that is, the quadrature signal has a functional connection (it is, for example, proportional) to the amplitude of the drive vibration of the active structure, that is, the movable part. Consequently, the quadrature signal is created by a movement that takes place in the same direction as the movement which represents the measuring signal, only shifted in phase (for example, by 900). Furthermore, the quadrature, together with a phase shift which always exists because of a not infinitely good resolution in a quadrature adjustment of the demodulation, causes a signal offset in the useful signal.

Thus, the quadrature signal may be evaluated in two manners. First, it may be evaluated by evaluating the signal offset that is caused by the quadrature. Second, it may be evaluated by putting a value on the actual quadrature signal by a demodulation according to this quadrature signal. This may be done in a conventional manner, for example, by evaluating the quadrature signal using a phase-sensitive amplifier, e.g., a lock-in amplifier.

The valuation of these signals may be made in two manners. The first manner is directly evaluating one of the two signals indicated before. This signal is compared in the evaluation electronic system to a value stored in a comparison table, and the result supplies a statement about the correct functioning of the sensor. The stored value is ascertained from the sensor data, during the calibration of the sensor, and is stored as zero value in the evaluation unit. The second manner makes use of the circumstance that the quadrature signal is proportional to the amplitude of the drive vibration of the active sensor. If the quadrature signal is proportional to the amplitude of the active sensor, then two different quadratures, in a first approximation, are at the same ratio to each other as the amplitudes which have generated these quadrature signals. A movable part in the form of a rotary oscillator oscillates, in an assumed example, once at 30 and once at 40 amplitude of the drive vibration. The following equation then applies:
3°/4°=Quad @ 3°/Quad @ 4°.

The signal offset may also be evaluated in the same manner.

An aspect of the second method is in the relative valuation of the signals, so that temperature effects or service life effects do not play an important part. Furthermore, this method is also independent of the absolute magnitude of the quadrature signal. Using this procedure, just as with the existing systems, both the mechanical mobility (because of the quadrature signal that has been created) and the electrical signal path (amplifier chain and demodulation path) are tested. In particular, usually the quadrature signal has a multiple amplitude of the actual useful signal, that is, also a multiple of the self-test signal used up to now.

A valuation of the correct function of a sensor according to an example embodiment of the present invention may take place both automatically in the starting case and also during operation by a change in the amplitude. In this connection, both an external request of the self-test and an autonomous execution of the self-test by the sensor are possible. As a countermove, the functionality is passed on outwards as “good” or “bad”, that is, a valuation of the self-test response by a microprocessor, etc., may no longer be necessary.

What is claimed is:

1. A sensor, comprising:
a self-test function;
a movable part having its own drive; and
an evaluation unit;
wherein a measured variable is represented by a deflection of the movable part with respect to a reference position, the drive adapted to provide at least one additional, parasitic deflection, the self-test function implemented by valuing the parasitic deflection in the evaluation unit.

2. The sensor according to claim 1, wherein an amplitude of the parasitic deflection is independent of an amplitude of the deflection by the measured variable.

3. The sensor according to claim 1, wherein the parasitic deflection takes place in the same direction as the measured variable.

4. The sensor according to claim 1, wherein the drive is adapted to set the movable part into a drive vibration.

5. The sensor according to claim 4, wherein the parasitic deflection is proportional to an amplitude of the drive vibration of the movable part.

6. The sensor according to claim 4, wherein the parasitic deflection is phase-shifted with respect to the deflection caused by the measured variable.

7. The sensor according to claim 6, wherein the self-test function is implemented by a phase-sensitive evaluation of the parasitic deflection

8. The sensor according to claim 6, wherein the self-test function is implemented by a phase-sensitive evaluation of the parasitic deflection using a phase-sensitive amplifier.

9. The sensor according to claim 4, wherein the parasitic deflection effects a signal offset of the measuring signal representing the measured variable.

10. The sensor according to claim 9, wherein the self-test function is implemented by evaluation of the signal offset of the measuring signal representing the measured variable.

11. The sensor according to claim 1, wherein the sensor is arranged as a micromechanical sensor.

12. The sensor according to claim 1, wherein the sensor is arranged as a rotation rate sensor.

13. The sensor according to claim 1, wherein the movable part is arranged as a seismic vibrating mass, the drive is designed as a capacitive drive structure that is suitable for setting the seismic vibrating mass into a drive vibration, and besides the amplitude of the drive vibration, the vibrating mass has an additional parasitic deflection in at least one measuring direction for the rotation rate.
